(19) United States
(12) Patent Application Publication
(10) Pub. No.: US 2009/0146971 A1
(43) Pub. Date: Jun. 11, 2009

(54) OPERATION DISPLAY DEVICE

(76) Inventor: Tatsuo NODA, Nishinomiya-shi (JP)

Correspondence Address: OSTROLENK FABER GERB & SOFFEN, 1180 AVENUE OF THE AMERICAS, NEW YORK, NY, 100368403, US

(21) Appl. No.: 12/326,315

(22) Filed: Dec. 2, 2008

(30) Foreign Application Priority Data
Dec. 5, 2007 (JP) 2007-315027

(51) Int. Cl. G06F 3/042; G06F 3/041

(52) U.S. Cl. 345/175; 345/173

(57) ABSTRACT

An operation display device including: a display section capable of simultaneously displaying different operation screens in a plurality of directions; a touch panel provided on the display section; an operation direction detection section which detects, among the plurality of directions, an operation direction on which an operator operating the touch panel is present; a coordinate detection section that detects, on the touch panel, a coordinate of a location pressed down by the operator; and a control section that sets, for each of the operation screens, correlations between operation icons displayed on the respective operation screens and recognition regions on the touch panel, and that, based on the operation direction detected by the operation direction detection section and correlations between the operation icons and the recognition regions, determines that an operation icon that corresponds to a recognition region including the coordinate of the location pressed down, is pressed down.

### BACKGROUND OF THE INVENTION

Priority is claimed on Japanese Patent Application No. 2007-315027, filed Dec. 5, 2007, the contents of which are incorporated herein by reference.

### FIELD OF THE INVENTION

The present invention relates to an operation display device, in particular, to an operation display device provided with a display section capable of displaying different images in a plurality of directions simultaneously, and with a touch panel provided on the display section.

### DESCRIPTION OF THE RELATED ART

In recent years, public attention has been drawn to display devices capable of simultaneously displaying different images in a plurality of directions such as with a so-called dual-view liquid crystal display that has a filter called a “parallax barrier” provided on the display surface of a liquid crystal panel, and that separates the direction of light emitted from the back light into left and right directions, to thereby display images that appear differently when seen from the right direction and when seen from the left direction. For example, Japanese Unexamined Patent Application, First Publication No. H6-236152 discloses a multiple video display device that has a lenticular lens configured with a plurality of cylindrical lenses provided on the display surface of the display device, and that is thereby capable of simultaneously displaying different images when seen from two directions.

Here, on the operation display device that has a touch panel provided on the liquid crystal panel having the above mentioned dual-view function, and that simultaneously displays different operation screens in two directions, two operators respectively perform different operations. However, in the conventional operation display device, the device is unable to recognize which operator is operating, and is therefore unable to determine in accordance with which one of two operation screens an operation should be performed. As a result, there is a possibility of operation failure in the conventional operation display device.

In view of the above-described circumstances, the present invention has an object of providing an operation display device that has a touch panel provided on a display section capable of simultaneously displaying different operation screens in a plurality of directions, and that is capable of accurately performing an operation in accordance with an operation input of the operator.

### SUMMARY OF THE INVENTION

In order to achieve the above object, the present invention employs the following. Namely, the present invention employs an operation display device including: a display section capable of simultaneously displaying different operation screens in a plurality of directions; a touch panel provided on the display section; an operation direction detection section which detects, among the plurality of directions, an operation direction on which an operator operating the touch panel is present; a coordinate detection section that detects, on the touch panel, a coordinate of a location pressed down by the operator; and a control section that sets, for each of the operation screens, correlations between operation icons displayed on the respective operation screens and recognition regions on the touch panel, and that, based on the operation direction detected by the operation direction detection section and correlations between the operation icons and the recognition regions, determines that an operation icon that corresponds to a recognition region including the coordinate of the location pressed down, is pressed down.

It may be arranged such that the operation direction detection section is provided with a plurality of light interception detection sensors.

It may be arranged such that the respective light interception detection sensors are provided on the outer edges of the surface of the touch panel each corresponding to the plurality of directions.

It may be arranged such that the operation direction detection section is provided with an image capturing device.

It may be arranged such that the operation direction detection section detects the operation direction by image-processing an image captured by the image capturing device.

It may be arranged such that the operation direction detection section is provided with a plurality of wired pens corresponding to the plurality of directions to be used for pressing down the touch panel.

It may be arranged such that the operation direction detection section detects the operation direction based on which one of the plurality of wired pens has pressed down the touch panel.

According to the above operation display device, in a configuration having a touch panel provided on a display section capable of simultaneously displaying different operation screens in a plurality of directions, it is determined, based on the operation direction detected by the operation direction detection section, and correlations between the operation icons and the recognition regions, that an operation icon that corresponds to the recognition region including the coordinate of the location pressed down, is pressed down. Therefore it is possible to accurately perform an operation in accordance with an operation input of the operator.

### BRIEF DESCRIPTION OF THE DRAWINGS

FIG. 1 is a functional block diagram of an operation display device 100 according to an embodiment of the present invention.

FIG. 2 is an operation flow chart of the operation display device 100 according to the embodiment.

FIG. 3A and FIG. 3B are explanatory diagrams related to operation screens of the operation display device 100 according to the embodiment.

FIG. 4A and FIG. 4B are examples of tables showing correlations, in the operation display device 100 according to the embodiment, between operation icons on an operation screen and recognition regions on a touch screen.

### DETAILED DESCRIPTION OF THE INVENTION

Hereunder, an embodiment of the present invention is described, with reference to the drawings.

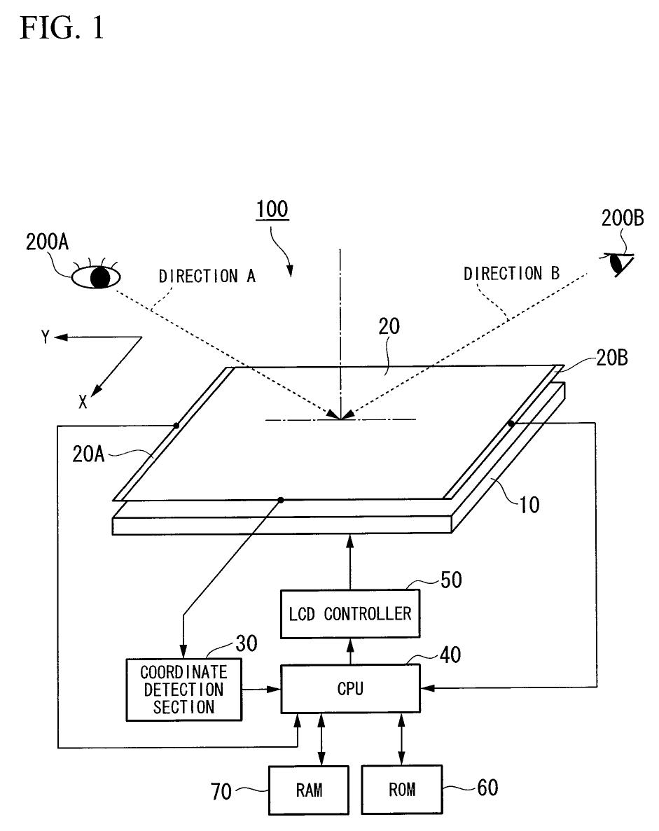

FIG. 1 is a schematic diagram showing a configuration of an operation display device 100 according to the present embodiment. As shown in FIG. 1, the operation display device 100 according to the present embodiment includes: a liquid crystal display 10; a touch panel 20; a first light interception detection sensor 20A; a second light interception detection sensor 20B; a coordinate detection section 30; a CPU (central processing unit) 40; an LCD controller 50; a ROM (read only memory) 60; and a RAM (random access memory) 70.

The liquid crystal display (display section) TO includes a liquid crystal panel and a back light, and simultaneously displays different operation screens (images for operation) in two directions (direction A and direction B) shown in the diagram, based on scanning signals, data signals, and back light control signals supplied from the LCD controller 50.

As a configuration of the liquid crystal display 10 capable of simultaneously displaying different operation screens in two directions in this way, a commonly known technique may be employed. A filter called a “parallax barrier” may be provided on the display surface of the liquid crystal panel, and the direction of the light from the back light may be separated into two directions to thereby display different operation screens when seen from the direction A and when seen from the direction B. Alternatively, the lens technique disclosed in Japanese Unexamined Patent Application, First Publication No. H6-236152 may be employed.

As shown in FIG. 1, in the present embodiment, the short side of the liquid crystal display 10 (touch panel 20) is set as the X axis direction, and the long side is set as the Y axis direction. The direction A is set as a direction in which the touch panel 20 is seen obliquely from above on one side in the Y axis direction, and the direction B is set as a direction in which the touch panel 20 is seen obliquely from above on the other side in the Y axis direction. Moreover, in this diagram, reference symbol 200A is given to the operator looking at the touch panel 20 from the direction A, and reference symbol 200B is given to the operator looking at the touch panel 20 from the direction B.

The touch panel 20 is provided on the liquid crystal display 10. This touch panel 20 employs an analog resistance film type detection for detecting coordinates of a position being pressed down, and the touch panel 20 outputs, to a coordinate detection section 30, analog voltage signals corresponding to the X coordinate and Y coordinate of the position being pressed down. This analog resistance film type is a commonly known technique, and detailed description thereof is therefore omitted. The first light interception detection sensor 20A is provided on the outer edge corresponding to the direction A on the surface of the touch panel 20. As this first light interception detection sensor 20A, for example an infrared sensor may be used. In this case, the infrared sensor outputs a light interception detection signal to a CPU 40 when interception of the infrared light thereof is detected. The second light interception detection sensor 20B is provided on the outer edge corresponding to the direction B on the surface of the touch panel 20. As this second light interception detection sensor 20B, for example an infrared sensor may be used. In this case, the infrared sensor outputs a light interception detection signal to the CPU 40 when interception of the infrared light thereof is detected. These first light interception detection sensor 20A and second light interception detection sensor 20B correspond to operation direction detection sections in the present invention.

The coordinate detection section (coordinate detection section) 30 digitally converts analog voltage signals corresponding to the X coordinate and Y coordinate input from the touch panel 20, to acquire a voltage value Vx corresponding to the X coordinate and a voltage value Vy corresponding to the Y coordinate, and it detects the X coordinate and Y coordinate of the position being pressed down based on these voltage values Vx and Vy. Furthermore, the coordinate detection section 30 outputs coordinate detection signals indicating these XY coordinates to the CPU 40.

The CPU (control section) 40, based on a control program stored in a ROM 60, generates image data and control signals required for displaying different operation screens in two directions (directions A and B), and outputs them to the LCD controller 50. This CPU 40, for these two operation screens, sets correlations between operation icons displayed on the respective operation screens and recognition regions on the touch panel 20. Furthermore, the CPU 40, based on the light interception detection signals input from the first light interception detection sensor 20A and the second light interception detection sensor 20B, and coordinate detection signals input from the coordinate detection section 30 to indicate the XY coordinates of the position being pressed down on the touch panel 20, determines which operation icon is being pressed down on which operation screen, and executes operations in accordance with the operation icon. Operation of this CPU 40 is described in detail later.

The LCD controller 50, based on image data and control signals input from the CPU 40, generates scanning signals, data signals, and back light control signals for operating the liquid crystal display 10, and outputs them to the liquid crystal display 10. The ROM 60 is a nonvolatile memory that stores the control program used by the CPU 40, and other data. The RAM 70 is a working memory used as a temporary data storage location for when the CPU 40 executes the control program and performs various operations.

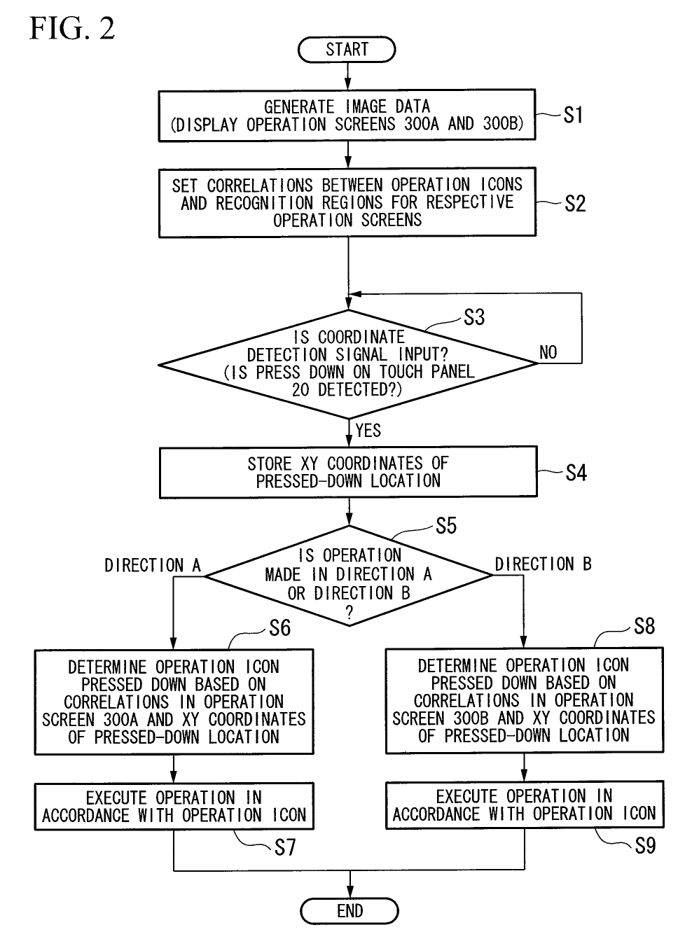

Next, the operation of the operation display device 100 according to the present embodiment configured as mentioned above, in particular, the operation of the CPU 40 is described, with reference to the flow chart in FIG. 2.

First, the CPU 40 generates image data and control signals required for displaying different operation screens in two directions (directions A and B), and outputs them to the LCD controller 50 (step S1).

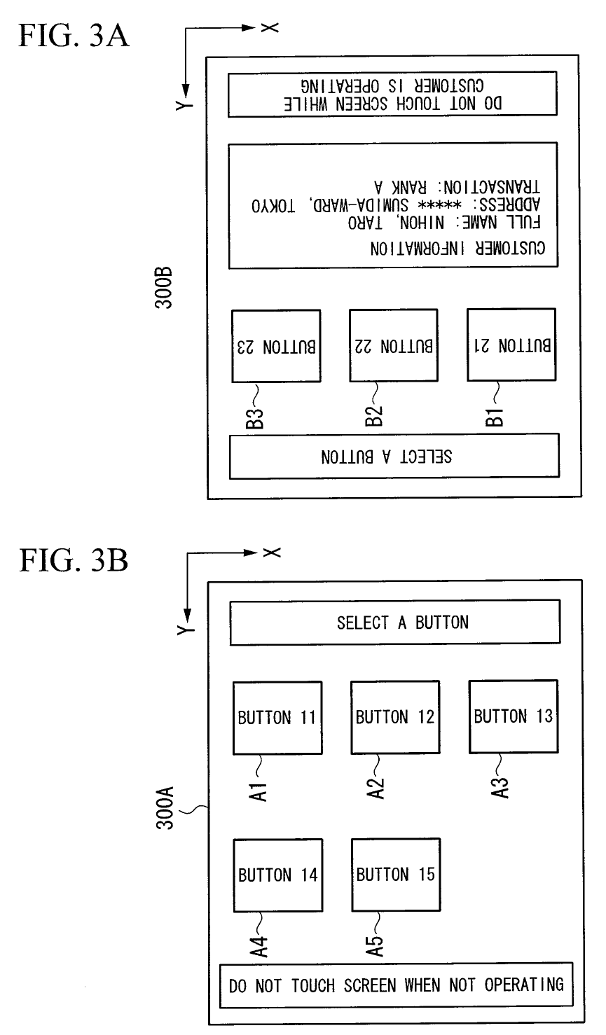

As a result, as shown in FIG. 3A and FIG. 3B, an operation screen 300A that can be seen from the direction A by the operator 200A (FIG. 3B), and an operation screen 300B that can be seen from the direction B by the operator 200B (FIG. 3A) are displayed on the liquid crystal display 10. As shown in FIG. 3A and FIG. 3B, the operation screen 300A displays operation icons A1, A2, A3, A4, and A5, and the operation screen 300B displays operation icons B1, B2, and B3.

Subsequently, the CPU 40, for the respective operation screens 300A and 300B, sets correlations between the operation icons displayed on the operation screens and recognition regions on the touch panel 20 (step S2). Here, the recognition region is a region where pressing-down performed on the panel 20 is recognized. The recognition region is information required for the CPU 40 to recognize an operation icon being the target of the operation, in the case where an operation with respect to the operation icon displayed on the operation screen (that is, pressing-down on the touch panel 20) is performed. It is preferable that this recognition be set so as to have the XY coordinates the same as those of the display region of the operation icon on the operation screen.

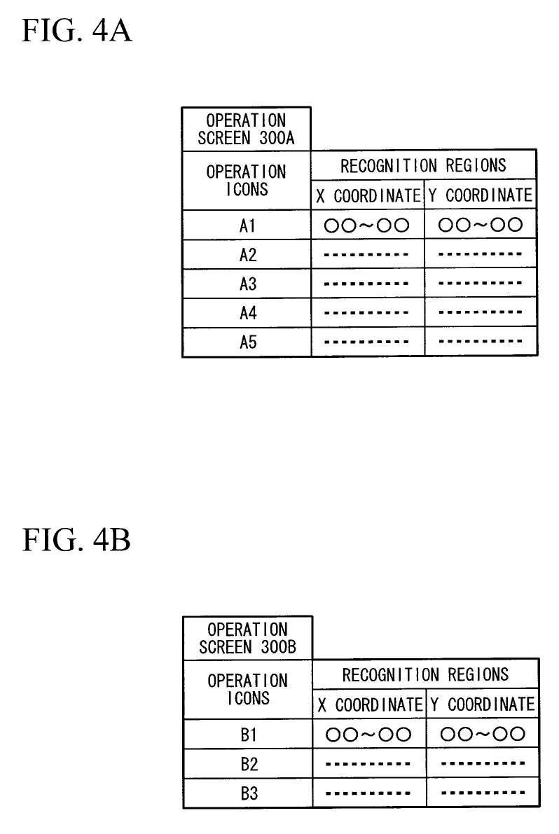

In this case, for example, on the operation screen 300A, the recognition region on the touch panel 20 corresponding to the operation icon A1 is set so as to have the XY coordinates the same as those of the display region of the operation icon A1 on the operation screen 300A. FIG. 4A and FIG. 4B show an example of tables showing correlations between operation icons and recognition regions on the operation screens 300A and 300B set as described above. The CPU 40 stores, into the RAM 70, table data indicating the correlations between the operation icons and recognition regions shown in FIG. 4A and FIG. 4B. In order to allow some margin in the recognition region, the recognition region may be set with a size slightly larger than that of the display region of the operation icon.

Subsequently, the CPU 40 determines whether or not a coordinate detection signal from the coordinate detection section 30 has been input, that is, whether or not the touch panel 20 has been pressed down (step S3). In the case where no coordinate detection signal has been input (“No”), the processing of step S3 is repeated, and the presence of pressing-down on the touch panel 20 is monitored. On the other hand, in the above step S3, in the case where a coordinate detection signal from the coordinate detection section 30 has been input (“Yes”), that is, in the case where the touch panel 20 has been pressed down, the CPU 40 stores, into the RAM 70, the XY coordinates of the location on the touch panel 20 being pressed down indicated by the coordinate detection signal (step S4).

Next, the CPU 40 determines whether the direction in which the operator who operated (pressed down) the touch panel 20 is present, is the direction A or direction B (step S5). For example, in the case where the operator 200A present on the direction A side operates the touch panel 20, the infrared light of the first light interception detection sensor 20A is intercepted, and a light interception detection signal is therefore output from the first light interception detection sensor 20A to the CPU 40.

Moreover, in the case where the operator 200B present on the direction B side operates the touch panel 20, the infrared light of the second light interception detection sensor 20B is intercepted, and a light interception detection signal is therefore output from the second light interception detection sensor 20B to the CPU 40. That is to say, in the above step S5, the CPU 40 monitors whether the light interception detection signal is output from the first light interception detection sensor 20A or from the second light interception detection sensor 20B, to thereby determine whether or not the operation direction, in which the operator who has operated (pressed down) the touch panel 20 is present, is the direction A or direction B.

In the above step S5, in the case where the operation direction is determined to be the direction A, that is, in the case where the operator 200A present on the direction A side has operated the touch panel 20 and a light interception detection signal has thereby been output from the first light interception detection sensor 20A to the CPU 40, the CPU 40 reads, from the RAM 70, table data indicating correlations between the recognition region and the operation icons displayed on the operation screen 300A corresponding to the direction A, and the XY coordinates of the location that has been pressed down. As a result, it is determined that the operation icon (any one of A1, A2, A3, A4, and A5) that corresponds to the recognition region including the XY coordinates of the location being pressed down, is pressed down (step S6). Subsequently, the CPU 40 executes an operation in accordance with the operation icon that has been determined to have been pressed down (step S7).

On the other hand, in the above step S5, in the case where the operation direction is determined to be the direction B, that is, in the case where the operator 200B present on the direction B side has operated the touch panel 20, and a light interception detection signal has thereby been output from the second light interception detection sensor 20B to the CPU 40, the CPU 40 reads, from the RAM 70, table data indicating correlations between the recognition region and the operation icons displayed on the operation screen 300B corresponding to the direction B, and the XY coordinates of the location that has been pressed down, and it is thus determined that the operation icon (any one of B1, B2, and B3) that corresponds to the recognition region including the XY coordinates of the location being pressed down, is pressed down (step S8). Subsequently, the CPU 40 executes an operation in accordance with the operation icon that has been determined to have been pressed down (step S9).

As described above, according to the operation display device 100 of the present embodiment, in the configuration having the touch panel 20 provided on the liquid crystal display 10 capable of simultaneously displaying different operation screens 300A and 300B in two directions, it is determined, based on correlations between the recognition regions and the operation icons displayed on the operation screen displayed on the operation direction side where the operator operating the touch panel 20 is present, that the operation icon that corresponds to the recognition region including the XY coordinates of the location on the touch panel 20 being pressed down is pressed down. Therefore it is possible to accurately perform an operation in accordance with the operation input of the operator.

The present invention is not limited to the above embodiment, and there may be considered modified examples as described below.

(1) In the above embodiment, there has been described an example of the case where the first light interception detection sensor 20A and the second light interception detection sensor 20B are used as operation direction detection sections. However, for example, it may be such that the touch panel 20 and the operators 200A and 200B are inclusively image-captured with use of an image capturing device such as camera, and an image acquired from this image-capturing is image-processed to thereby detect whether it is operated by the operator 200A (direction A) or operated by the operator 200B (direction B). Moreover, it may also be such that a wired pen for the direction A and a wired pen for the direction B are provided, and it is determined which one of these pens has pressed down the touch panel 20, to thereby detect whether it is operated by the operator 200A (direction A) or it is operated by the operator 200B (direction B).
(2) In the above embodiment, there has been described an example of the case where different operation screens are simultaneously displayed in two directions. However, the present invention may also be applied to a case of displaying different operation screens in three or more directions. Moreover, the liquid crystal display 10 has been illustrated as an example of a display device that displays different operation screens in a plurality of directions. In addition to this, however, an organic EL display, a plasma display, or the like may be used as long as it is capable of displaying different operation screens in a plurality of directions.
(3) In the above embodiment, there has been described an example of the case where the operation display device 100 is operated as a stand alone device. However, the operation display device 100 according to the present embodiment may be used as an operation display device for an office automation device such as a facsimile device and a photocopy device, a portable terminal such as a PDA, a car navigation terminal, or other types of information devices.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An operation display device comprising:
a display section capable of simultaneously displaying different operation screens in a plurality of directions;
a touch panel provided on the display section;
an operation direction detection section which detects, among the plurality of directions, an operation direction on which an operator operating the touch panel is present;
a coordinate detection section that detects, on the touch panel, a coordinate of a location pressed down by the operator; and
a control section that sets, for each of the operation screens, correlations between operation icons displayed on the respective operation screens and recognition regions on the touch panel, and that, based on the operation direction detected by the operation direction detection section and correlations between the operation icons and the recognition regions, determines that an operation icon that corresponds to a recognition region including the coordinate of the location pressed down, is pressed down.

2. The operation display device according to claim 1, wherein
the operation direction detection section is provided with a plurality of light interception detection sensors.

3. The operation display device according to claim 2, wherein
the respective light interception detection sensors are provided on the outer edges of the surface of the touch panel each corresponding to the plurality of directions.

4. The operation display device according to claim 1, wherein
the operation direction detection section is provided with an image capturing device.

5. The operation display device according to claim 4, wherein
the operation direction detection section detects the operation direction by image-processing an image captured by the image capturing device.

6. The operation display device according to claim 1, wherein
the operation direction detection section is provided with a plurality of wired pens corresponding to the plurality of directions to be used for pressing down the touch panel.

7. The operation display device according to claim 6, wherein
the operation direction detection section detects the operation direction based on which one of the plurality of wired pens has pressed down the touch panel.
